(19) United States
(12) Patent Application Publication
(10) Pub. No.: US 2008/0128529 A1
(43) Pub. Date: Jun. 5, 2008

(54) Combined drinking straw with mixer

(76) Inventor: Rodolfo Fernandez, Kings Mountain, NC (US)

Correspondence Address: RODOLFO FERNANDEZ, 308 FULTON STREET, KINGS MOUNTAIN, NC, 28086, US

(21) Appl. No.: 11/633,290

(22) Filed: Dec. 4, 2006

(51) Int. Cl. A47G 21/18; B01F 13/00

(52) U.S. Cl. 239/33; 366/129

(57) ABSTRACT

A Combined Drinking Straw with Mixer, disposable or reusable, consisting in a drinking straw to sip beverages with its intake end provided with conveniently shaped radial vanes each provided with a hole at alternate positions which, when immersed into a beverage in any suitable container, impart a whirling effect to said beverage when the user conveniently twirls the drinking straw with his/her hands or fingers, thereby mixing or improving the homogenization and blend of the beverage, being this feature particularly useful with beverages made with ice cream and milk or soda, or flavored powder with milk or other liquids, or even cocktails with ice, and, in addition, it may be provided with appealing advertising attachments and this utensil may be offered to consumers as option to mix beverages by themselves, saving time and energy, particularly in Fast Food Services.

### CROSS REFERENCE TO RELATED APPLICATIONS

(Not Applicable)

### STATEMENT REGARDING FED. SPONSORED R & D

(Not Applicable)

### REFERENCE TO SEQUENCE LISTING

(Not Applicable)

### BACKGROUND OF THE INVENTION

This invention relates to drinking straws and particularly to variations of drinking straws with modifications or attachments intended for combined functions additional to their main purpose of sipping beverages which, in this case, consists in that the drinking straw is modified to perform also as a mixer, driven by the user's hands or fingers, to improve the quality and flavor of beverage mixtures, such as cocktails and/or milk or water with flavored granules and/or dense syrups and/or ice cream, and/or to accelerate the cooling of beverages with ice, very easily, by means of the same device used to sip the beverage from the container.

The author had the opportunity to sip a dense ice cream shake using a reusable glass drinking straw with a spoon-like end and found the combination very practical and useful thereof, based on that experience, conceived the idea to provide an end of drinking straws with attached or integrated elements to perform as mixers, so that the user, twirling manually in a proper way the drinking straw so modified, is able to mix or improve the mixing of beverages composed by two or more substances, as well as accelerate the cooling of a beverage mixed with ice very easily and with little effort, thereafter using it like any common drinking straw to sip the beverage, instead of using complex and more expensive electro-mechanical appliances,

After a thorough search, the author found that since long time ago, many patents have been issued to variations and improvements to drinking straws, mainly related to modifications to use drinking straws as spoons, stirrers and mixers, showing, teaching and claiming very similar shapes, uses and performance, with little differences among them.

Those patents that the author considers relevant are listed in the References Cited above and are briefly discussed below, but no prior art drinking straw patent found has the same features of the object of this invention.

The nearest prior art to the object of the present invention, is the Swirling and Mixing Sipping Straw, U.S. Pat. No. 2,613,107 filed by P. L. Hartnett on Sep. 14, 1950, which teaches a sipping straw with an end modified provided with radially extended flat stirring blades to cause the mixing of beverages driven by the user's hands or fingers.

But in Hartnett's invention, on one hand, the blades are solid, so they are not provided with openings as the object of the present invention, being said openings an important feature to improve the mixing effect, and on the other hand, the Combined Drinking Straw with Mixer teaches further improvements, not taught by Hartnett's invention, such as an offset crank-like modification of a portion of the drinking straw or a knob-like attachment conveniently configured to provide a better leverage for the user to twirl the device mixing beverages relatively dense such as ice cream with milk shakes.

U.S. Pat. No. 2,979,267, Drinking Tube, filed on Jun. 18, 1958 by Frederik W. Miller, teaches a drinking straw provided with fin-shaped elements evenly spaced to be used as stirrer driven by the user's hands or fingers. Those elements have the form of spoon shells and are provided with grooves, but not with openings as is the case in the object of the present invention.

U.S. Pat. No. 3,315,405, Drinking Straw Attachment, filed on Sep. 23, 1964 by A. L. Hoffer is another prior art patent closely related to the same field, consisting in an attachment provided with radial blades to use a sipping straw as mixer.

Although Hoffer's invention is likely to provide an effective mixing effect, the attachment comprises helical blades distributed in two concentric sets, being the inner set of helical blades allocated inside the lower widened section of the attachment therefore interfering with the flow of the beverage being sipped, and, in addition, its configuration is rather complex and the helical blades are not quite effective when manually driven, particularly with dense beverage mixtures.

U.S. Pat. No. 6,056,206, Combination Straw, Stirrer and Citrus Fruit Squeezer, filed on Dec. 7, 1998 by Whiton, is particularly intended to squeeze citrus fruits and mix the extracted juice manually moving the modified drinking straw, combining axial and tilting relatively vigorous movements, being the shapes and uses taught in said invention patent very different to the object of the present modified drinking straw, which is not intended to squeeze fruits and wherein the manual motion imparted is mostly rotational and relatively gentle.

Prior art U.S. Pat. No. 6,561,434 B2, Straw for Sipping Liquid, issued on May 12^{th}, 2003 to Barry Kaplan, refers to a drinking straw with its immersed end modified to cause a whirling effect in the liquid being sipped by means of the fluid flow through ramified ducts or by means of a thin plate normal to the axis of the straw provided with openings and/or protuberances, so that it rather works with axial movements and does not cause a mechanical rotating mixing effect in the beverage, as does the Combined Drinking Straw with Mixer object of the present invention, which is conveniently driven by the user's hand or fingers, particularly advantageous when the beverages to mix and sip are dense, in a way resembling the effective mixing provided by electro-mechanical mixers.

Furthermore, neither the above mentioned inventions, nor any other prior art found in this field, provide convenient modifications or attachments to the drinking straw to increase the mixing driving action of the user's hands or fingers as does the Combined Drinking Straw with mixer object of the present invention, which has been successfully tested by the author.

Although this Combined Drinking Straw with Mixer can be in all or in part reusable, it comprises very low cost components that can be produced by means of well known large scale manufacturing processes using available low cost materials, to supply it as a new attractive disposable utensil within the fast food services and particularly useful where dense ice cream milk shakes are served.

### BRIEF SUMMARY OF THE INVENTION

It is the purpose of the present invention, to provide drinking straws users with an additional useful feature, consisting in the modification of an end of a drinking straw in such a way that when it is immersed into a beverage comprising two or more different substances, the user can twirl it manually with very little effort in a convenient way, to mix or improve the mixing or blend of the beverage with no need of electrical or complex devices and thereafter use it as a common drinking straw to sip the beverage.

The modified end of the drinking straw can be an attachment securely fixed, or an integral part of the straw, conveniently shaped to form mixing blades.

This Combined Drinking Straw with Mixer, can be disposable or made of suitable materials to make it washable/reusable.

Furthermore, this Combined Drinking Straw with Mixer can be used in conjunction with a common or a special lid, disposable or reusable, to fit on top of disposable or reusable glasses, inserting the straw through a center hole in the lid, in order to prevent any mixture spillage during the mixing operation.

This Combined Drinking Straw with Mixer can be manufactured with any suitable material or combinations of materials, in a great variety of shapes and colors, thus providing the device with attractive appearance and making it appropriate for diverse kind of beverage mixtures.

In addition, this Combined Drinking Straw with Mixer, can be provided with an integrated or with a separate element to increase the driving torque applied by the user's hands or fingers, and at the same time, said element may be used to exhibit commercial logos or decorative figures.

The extensive use of this Combined Drinking Straw with Mixer, as an additional important advantage, will provide the Fast Food Services Business with the possibility to offer the consumers the option to mix manually by themselves, in a very efficient way, beverages such as those comprising ice cream and milk or soda, adding fun to the consumption of said beverages, with significant labor time and energy costs savings.

These features and advantages, and some others, will become evident to those skilled in the art through the drawings and their descriptions illustrating the present invention.

### BRIEF DESCRIPTION OF THE DRAWINGS

FIG. 1 shows a simple embodiment of the Combined Drinking Straw with Mixer object of the present invention with a modified and provided with two opposite blades.

FIG. 2 shows a section elevation view of a glass with a lid through which is inserted a Combined Drinking Straw with Mixer like that previously shown in FIG. 1, while it is being rotated by the user's hand.

FIG. 3 shows an alternate embodiment of the invention in which a portion of the combined drinking straw is offset to form a sort of little crank, while the modified mixer end is provided with four radial blades.

FIG. 4 shows a section view of a glass with a lid and an alternate embodiment of the invention with a two radial blades mixer attachment at its intake end and a second special attachment properly shaped fixed to the upper portion of the drinking straw to facilitate the action of rotating or twirling the Combined Drinking Straw with Mixer by the user's hands or fingers.

FIG. 5 is an exploded view that shows the embodiment of the invention previously shown in FIG. 4 with all its components apart.

### DETAILED DESCRIPTION OF THE INVENTION

The Combined Drinking Straw with Mixer object of the present invention comprises two basic elements but can be provided with diverse supplementary components.

The two basic elements are: a drinking straw and a set of attached or integrated mixing elements at the intake end of the drinking straw that is immersed into the beverage to mix and sip.

One supplementary component can be a commercially available or a specially configured lid with an orifice to insert through the Combined Drinking Straw with Mixer, in order to prevent spillage of the beverage from the container, usually a commercially available disposable glass, during the mixing performance.

Another supplementary component can be a specially shaped attachment fixed to the upper portion of the drinking straw, to facilitate the action of the user's fingers to the Combined Drinking Straw with Mixer when it is used to mix the beverage.

This Combined Drinking Straw with Mixer can be in all or in part, disposable like most common drinking straws commercially available, or made of any suitable washable and reusable material.

This Combined Drinking Straw with Mixer is used like any drinking straw to sip a beverage from a container, but in addition, can be twirled by the user's hands or fingers, with very little effort and with no need of electrical or complex devices, to mix beverages composed of two or more different substances or to accelerate the cooling of a beverage with ice.

All components of the present invention, in all their possible variations, can be produced using ordinary manufacturing processes that allow high rates of production, are highly efficient and reliable, and are well known in the field of supplies for the fast food services in general and beverage consumption in particular.

In the consecutive drawings, the same or equivalent components or parts of components are designated with the same reference character of three digits, wherein from left to right the third digit identifies the function of the part and the first indicates the figure where it was first shown with the same configuration, since there are many different possible shapes for a same component or part of component.

Most main features of the Combined Drinking Straw with Mixer are explained below in the detailed description of the illustrative drawings, however, the embodiments of the components of the present invention may be much more diversified than those shown in the following figures.

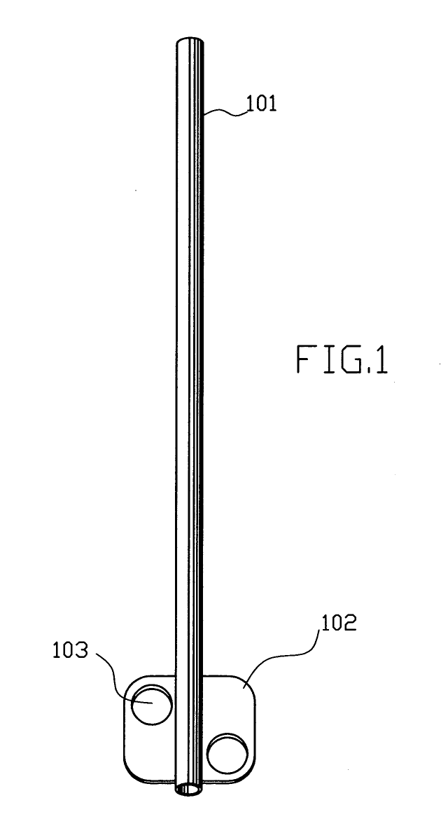

FIG. 1 shows an elevation view slightly tilted of a simple embodiment of the Combined Drinking Straw with Mixer object of the present invention which comprises an upper part 101 consisting like common drinking straw, in an elongated cylindrical tube, and its lower or intake end to be immersed into the beverage to sip has two opposite radial flat blades or vanes 102, with rectangular shape, each provided with a hole 103 located at different alternate positions.

The vanes 102 are conveniently shaped and dimensioned to freely enter and rotate inside common beverages containers such as disposable glasses.

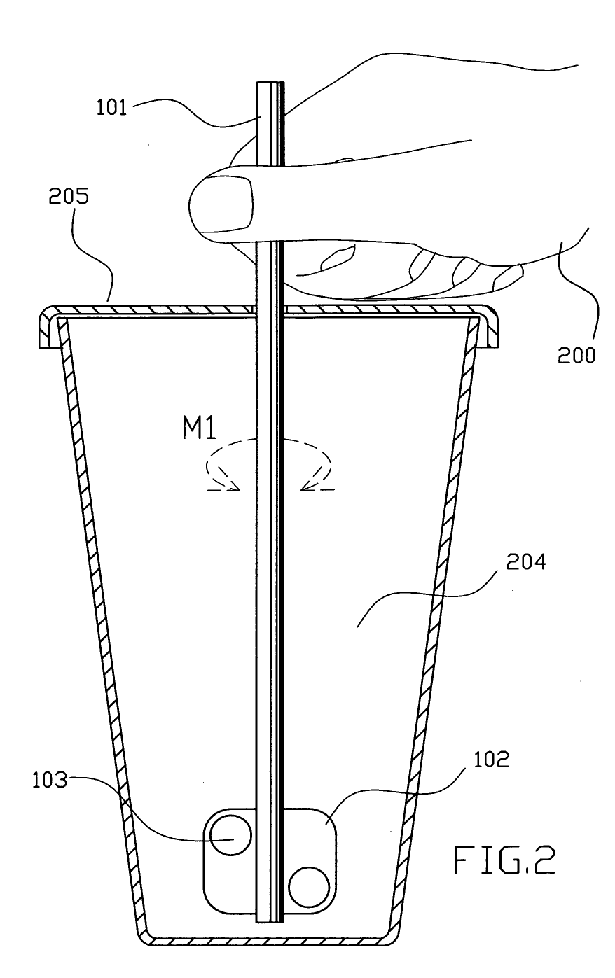

FIG. 2 shows an axial section view of the same embodiment of the Combined Drinking Straw with mixer previously shown in FIG. 1, introduced inside a glass 204, through the central hole of a lid 205 fitted on top of the glass 204, while the user's hand 200 holds the upper portion 101 of the Combined Drinking Straw with Mixer to twirl it clock and counterclockwise as indicated by the double arrow head dashed line M1, so that the vanes 102 with the holes 103 immersed in the beverage contained in the glass and comprising two or more substances, impart a whirling motion to the beverage, providing a very effective mixing of the beverage, particularly because the holes 103 located at different positions on the blades 102, force the fluid to abrupt changes in the direction of the flow.

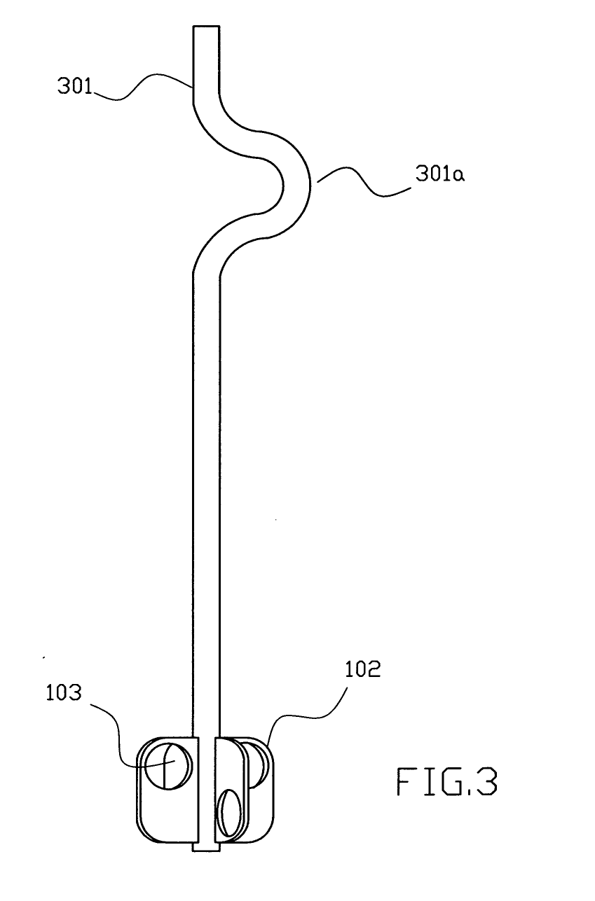

FIG. 3 shows an elevation view of the Combined Drinking Straw with Mixer, whose upper portion, near its top end 301 is bent in an offset crank-like shape 301a, to make easier to the user the mixing action in dense beverages, such as, but not limited to, ice cream with milk or soda, increasing the torque applied with little effort by the user's fingers to mix the beverage, by means of the lower or intake end immersed in the beverage and provided in this case with four radial flat vanes 102 protruding outwardly around it, in radial planes evenly spaced at angles of 90 degrees, aligned with the geometrical axis of the drinking straw, and each vane, in turn, is provided with holes 103 located at alternate positions.

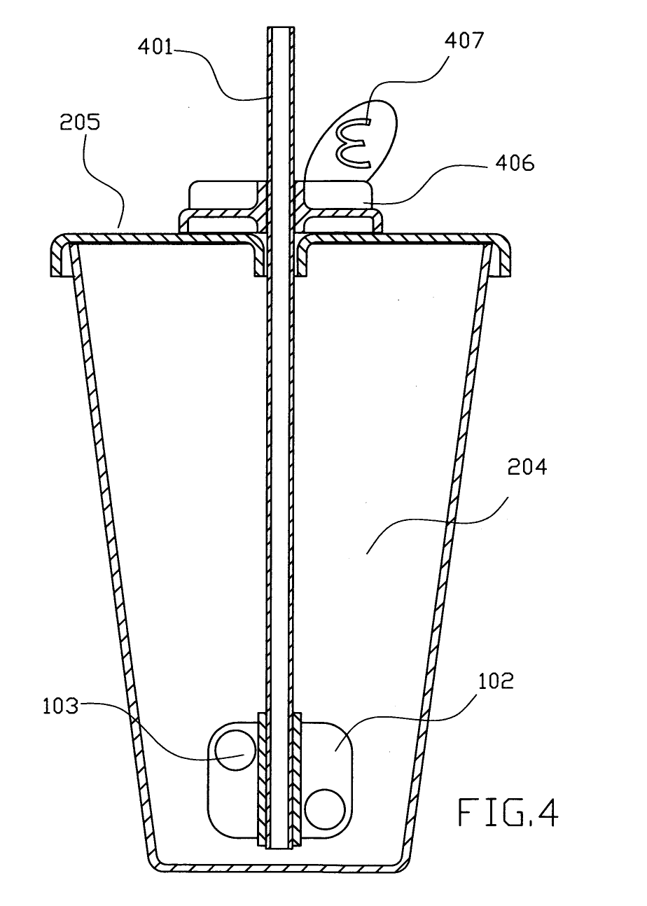

FIG. 4 shows an axial section elevation view of an alternate embodiment of the present invention, inserted into a glass 204, through the central hole of a special lid 405 properly fitted to the upper rim of the glass.

This alternate embodiment comprises a common drinking straw 101, to whose lower or intake end is properly fitted a mixer attachment 402, with several radial vanes 102, although only two opposite radial blades are shown in this figure, each provided with the holes 103 at alternate positions.

In this figure, is shown a knob-like attachment 406, which is affixed to the upper and sipping end of the straw 401 above the lid 405, being said knob-like attachment 406 shaped like a disc concave downward to reduce undesirable spillage of the beverage during the mixing action and with its top provided with tiny levers to increase the little effort applied by the user's fingers to mix dense beverages, such as, but not limited to, ice cream with milk shakes.

The knob-like attachment 406, as shown in FIG. 4, can be also provided with a prominent surface 407 to exhibit advertisement images.

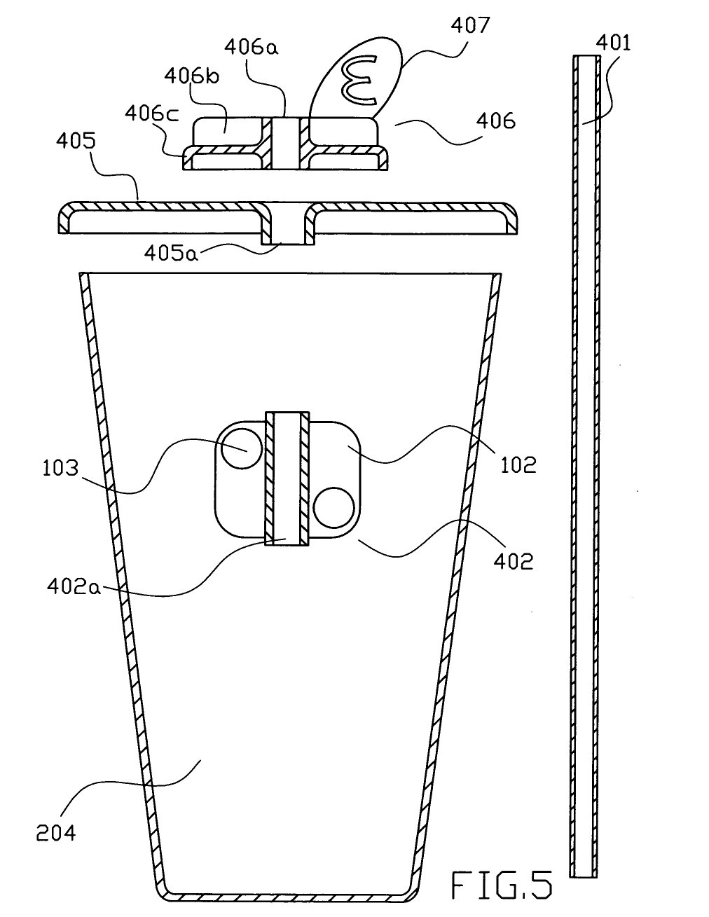

FIG. 5 shows an exploded elevation view in axial section of the components of the embodiment of the invention previously shown in FIG. 4.

Below at left on FIG. 5 is shown a glass 204, and at right is shown a common drinking straw 401, to which are to be attached the special components shown further in this same figure.

Near the upper left corner of this figure is shown the knob-like attachment 406; below it is shown the special lid 405, and at the lower left corner is shown an axial section view of the mixer attachment 402 inside the glass 204.

The knob-like attachment 406 consists in a hollow central hub 406a with its outer upper cylindrical portion provided with several radial tiny flat blades or levers 406b, for the user to drive the Combined Drinking Straw with Mixer, twirling it rapidly with his/her fingers.

The lower end of the knob-like attachment 406 is surrounded by a thin disc 406c with its lower surface concave, to prevent beverage spillage during the manual mixing performance.

The hole in the central hollow hub 406a of the knob-like attachment, must be properly shaped and dimensioned with an inner diameter substantially equal to the outer diameter of the drinking straws currently used, so that either the user him-herself, or an attendant, may easily slide said knob-like attachment to reach the desired position with appropriate fit onto the drinking straw after having inserted it through the central hole in the lid 405.

The special lid 405 must be conveniently shaped and dimensioned to fit properly onto the upper rim of beverage containers, such as reusable glasses or disposable glasses frequently used in fast food services.

In addition, said special lid 405 has a hollow central hub 405a, which must have an inner diameter slightly bigger than the outer diameter of the drinking straw to facilitate the insertion of the drinking straw through it, and with the purpose to provide an improved bearing for the Combined Drinking Straw with Mixer while it is twirled by the user.

The mixer attachment 402, has a central hollow hub 402a, from which protrude outwardly a plurality of radial vanes 102, two shown in this case, in radial planes evenly spaced around the central hollow hub 402a, being said vanes aligned with the central hub geometrical axis and accordingly aligned with the geometrical axis of the drinking straw to whose intake end the mixer is attached.

Each radial vane 102 is provided with a hole 103, located at alternate positions in adjacent radial blades.

The radial vanes 102 must be conveniently shaped and dimensioned to enter and move freely inside the container of the beverage.

The diameter of the inner hole of the central hollow hub 402a must be substantially equal to the outer diameter of the drinking straw, in order to provide an appropriate tight fit onto its lower intake end.

The components of the Combined Drinking Straw with Mixer can be manufactured using low cost non-toxic materials and well known large scale manufacturing processes, in such a way that some or all of them can be either disposable or reusable.

The above description with reference to the figures is considered to be illustrative and not restrictive. The true scope and spirit of the invention resides in the appended claims and their legal equivalents, rather than in the given examples. Modifications and variations on the embodiments described, or known to those skilled in the art, may be made within the scope of the invention.

What is claimed as invention is:

1. A Combined Drinking Straw with Mixer consisting in a drinking straw used to sip beverages, wherein said drinking straw has its intake end modified with at least two radial protuberances, which are flat properly shaped vanes conveniently dimensioned to enter and move freely into commonly used containers such as, but not limited to commercially available glasses, each vane being provided with holes at different positions, and said radial vanes protrude outwardly from the drinking straw in radial planes aligned with the geometrical axis of the drinking straw, so that when said modified end of the drinking straw is immersed into a beverage comprising two or more substances, a whirling mixing effect is imparted to said beverage when the user manually drives the Combined Drinking Straw with Mixer, twirling and moving it with his/her hands or fingers, thereof contributing to the mixing of said beverage in a way similar to electro-mechanical mixers.

2. A Combined Drinking Straw with Mixer as set forth in claim No 1, wherein the upper portion of said drinking straw which remains out of the beverage is configured to form a crank-like offset providing a way to increase the torque applied by the user's fingers, therewith reducing the little effort required to manually agitate and mix dense beverages such as ice cream with milk.

3. A Combined Drinking Straw with Mixer, wherein at the intake lower end of a drinking straw currently used to sip beverages, is affixed a mixer attachment which consists in a central hollow hub with an axial open hole conveniently shaped and dimensioned to properly fit to said drinking straw, and from said central hub protrude a plurality of flat vanes protruding outwardly in radial planes evenly spaced and aligned with the geometrical axis of the drinking straw, being each vane conveniently shaped and dimensioned to enter and move freely into the beverage container and provided with holes at alternate positions in adjacent vanes, thereby said end of the drinking straw with said mixer attachment is immersed into a beverage comprising two or more substances, and a whirling mixing effect is imparted to said beverage when the user manually drives the Combined Drinking Straw with Mixer, twirling and moving it with his/her hands or fingers, therefore contributing to the mixing of said beverage in a way similar to electro-mechanical mixers.

4. A Combined Drinking Straw with Mixer as set forth in claim No 3, wherein a reusable separate knob-like attachment is affixed to the portion of said drinking straw that remains out of the container, near the sipping upper end of said drinking straw, being said knob conveniently shaped as, but not limited to, a central hollow hub surrounded by a concave downward disk around its lower section to reduce the occurrence of spillage of the beverage being agitated or mixed, and the axial hole through the central hollow hub is conveniently shaped and dimensioned to insert through it and fix the drinking straw, while the upper part of said hub has one or more protruding flat radial levers, to provide the user a way to increase the torque applied by his/her fingers, thus reducing the little effort required to manually agitate and mix beverages such as dense ice cream with soda.

5. A Combined Drinking Straw with Mixer as set forth in claim No 3, wherein before the attachment of said knob-like piece, the drinking straw is passed through the center hollow hub of a especially shaped lid with an outer rim properly shaped and dimensioned to fit onto the container of the beverage being the central axial hole in said hollow hub properly shaped and dimensioned to reduce the occurrence of spillage of the beverage being agitated or mixed, and at the same time, to provide a convenient bearing for the manual movement of the Combined Drinking Straw with Mixer.

6. A Combined Drinking Straw with Mixer as set forth in claim No 3, wherein said radial levers on said knob-like attachment are shaped and dimensioned to provide appropriate surfaces to exhibit advertisement images.

7. A Combined Drinking Straw with Mixer as set forth in claims No 1 or 3, wherein all components are made of any suitable material, such as, but not limited to, nontoxic plastics with different colors and textures.
